(19) United States
(12) Patent Application Publication
(10) Pub. No.: US 2013/0205646 A1
(43) Pub. Date: Aug. 15, 2013

(54) COLLAPSIBLE FISH TRAP

(71) Applicant: Levi George McPhee, Nassau (BS)

(72) Inventor: Levi George McPhee, Nassau (BS)

(21) Appl. No.: 13/396,928

(22) Filed: Feb. 15, 2012

(51) Int. Cl. A01K 69/10

(52) U.S. Cl. 43/105

(57) ABSTRACT

A collapsible fish trap. The fish trap has a funnel and a swing door. The fish trap uses biodegradable screws and a latching system. The fish trap is made to collapse after a certain period of time of being in the water.

### BACKGROUND OF THE INVENTION

1. Introduction

Give a man a fish, and he eats for a day. Teach a man to fish and he eats for life. However, regardless of what he knows, the right tools are needed to catch the fish.

Nets, spears, traps and baited hooks are all prior means used to catch fish. Each has its limitations and each its advantages.

A fish trap is a trap used for fishing. Fish traps may have the form of a fishing weir or a lobster trap. A typical trap might consist of a frame of thick steel wire in the shape of a heart, with chicken wire stretched around it. The mesh wraps around the frame and then tapers into the inside of the trap. When a fish swims inside through this opening, it cannot get out, as the chicken wire opening bends back into its original narrowness.

Fish Traps are culturally almost universal, having been independently invented many times. Two types of trap generally exist - a permanent or semi-permanent structure placed in a river or tidal area, and pot-traps that are baited to attract fish and periodically . lifted.

The manner in which fish traps are used depends on local conditions and the nature of the local fish. For example, a fish trap might be placed in shallow water near rocks where fish like to lie.

If placed correctly, traps can be very effective. It is usually not necessary to check the trap daily, since the fish remain alive inside the trap, relatively unhurt.

2. Field of the Invention

The present invention relates to a collapsible fish trap and a kit for assembling a fish trap.

3. Description of the Prior Art

Fish traps are disclosed in U.S. Patents. U.S. Pat. No. 7,533,486, to Ribeiro De Matos teaches a box-like fish trap which is foldable.

U.S. Pat. No. 5,632,114 to McKenzie teaches a fish or crustacean collapsible trap.

U.S. Pat. No. 5,218,781 to Miller teaches a collapsible king crab pot with one-piece net. Miller's net is suspended within a collapsible scaffold or frame.

U.S. Pat. No. 4,251,943 discloses a collapsible fish trap formed from hare foamed plastic segments.

U.S. Pat. No. D494,653 to Long is a design patent directed toward an ornamental design for collapsible four-door crab trap.

Fish traps are also disclosed in U.S. Patent Applications. U.S. Patent Application 2099/0217567 discloses a collapsible trap particularly suitable as a crab pot for trapping crabs.

U.S. Patent Application 2099/0217567 discloses an improved crustacean trap comprising a collapsible frame.

### BRIEF SUMMARY OF THE INVENTION

The present invention is directed to a collapsible fish trap. The fish trap comprises of a square front panel. The square front panel defines a funnel, three top t-front panel guides and three bottom t-panel guides. Each t-front panel guide runs perpendicular to the top and bottom border of the front panel. All borders of the front panels define front panel apertures. The square front panel is constructed so that the edge of each front panel defines at least a 3 inch border and the panel is made of a hard plastic material. The fish trap further comprises of two identical side panels. Each side panel is also made of a hard plastic. Each side panel's top and bottom side define t-side panel guides that run along the length of each side panel. Each side panel's left and right side define solid edges that define at least one side aperture. The fish trap further comprises of a top and bottom rectangular panel, each rectangular panel defines a longer and a shorter side. Each top and bottom panel is made of hard plastic. The top and bottom rectangular panels define edges and each edge has a 3 inch border. Each sides edge that runs along the length of the longer sides of each rectangular panel defines a t-receiving channel and the side edges that run along the length of the shorter sides of each rectangular panel define a central t-receiving channel that runs perpendicular to the length of the shorter sides, the shorter sides of each rectangular panel further defines two rectangular panel apertures, each rectangular panel aperture is adjacent to the central t-receiving channel. The fish trap further comprises of a square rear panel. The square rear panel defines a swing door, three top t-rear panel guides and three rear t-panel guides. Each t-rear panel guide runs perpendicular to the top and bottom borders of each rear panel. All borders of the rear panels define a plurality of rear panel apertures. The square rear panel is constructed so that the edge of each rear panel defines at least a 3 inch border and the rear panel is made of a hard plastic material. All panels are made of a hard plastic lattice that allow liquids to flow through. The fish trap further comprises of a plurality of screws. The screws are screwed within in apertures of the panels after the fish trap is assembled.

The fish trap is assembled by first placing the bottom side panel on a surface (not shown in drawings) so that the t-receiving channels face upward, then inserting the side panel's t-side panel guides within the t-receiving channels of the bottom side panel, next, sliding the top side panel's t-receiving channels on the side panel's t-side panel guides, then inserting the front panel's t-front panel guides within the t-receiving channels of the top side and bottom side panels, next inserting the rear panel's t-rear panel guides within the t-receiving channels of the top side and bottom side panels, and lastly securing all of the panels together by screwing the screws within the panels apertures.

It is an object of the present invention to provide a collapsible fish trap that can easily be assembled and disassembled, wherein the design of the fish trap shall allow small boats to maximize the amount of traps that can be transported.

Another object of the present invention is to provide a trap that will be ecologically friendly.

A further object of the present invention is to provide an economical, easy to manufacture, and serviceable fish trap.

Other objects and further scope of applicability of the present invention will become apparent from the detailed description given hereinafter. However, it should be understood, that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE SEVERAL VIEWS OF THE DRAWING

The present invention will be better understood from the detailed description given herein below and the accompanying drawings with which are given by way of illustration only:

FIG. 1 shows a perspective view of the present invention assembled;

FIG. 2 shows a perspective view of the present invention wherein all of the panels and elements of the invention are positioned to mount on the bottom panel of the fish trap;

FIG. 3 shows a perspective view of the present invention showing the funnel flowing away from the viewer;

FIG. 4 shows a perspective view of the present invention showing the funnel flowing toward the viewer;

FIG. 5 shows a perspective view of the present invention showing the square rear panel of the present invention showing the swing door of the present invention, the swing door would open toward the viewer;

FIG. 6 shows a perspective view of the present invention showing the square rear panel of the present invention showing the swing door of the present invention, the swing door would open away from the viewer;

FIG. 7 shows a perspective view of the top rectangular panel of the present invention;

FIG. 8 shows a perspective view of the bottom rectangular panel of the present invention;

FIG. 9 shows a perspective view of one of the side panels of the present invention; and

FIG. 10 shows a mirror image of the side panel shown in FIG. 9.

### DETAILED DESCRIPTION OF THE INVENTION

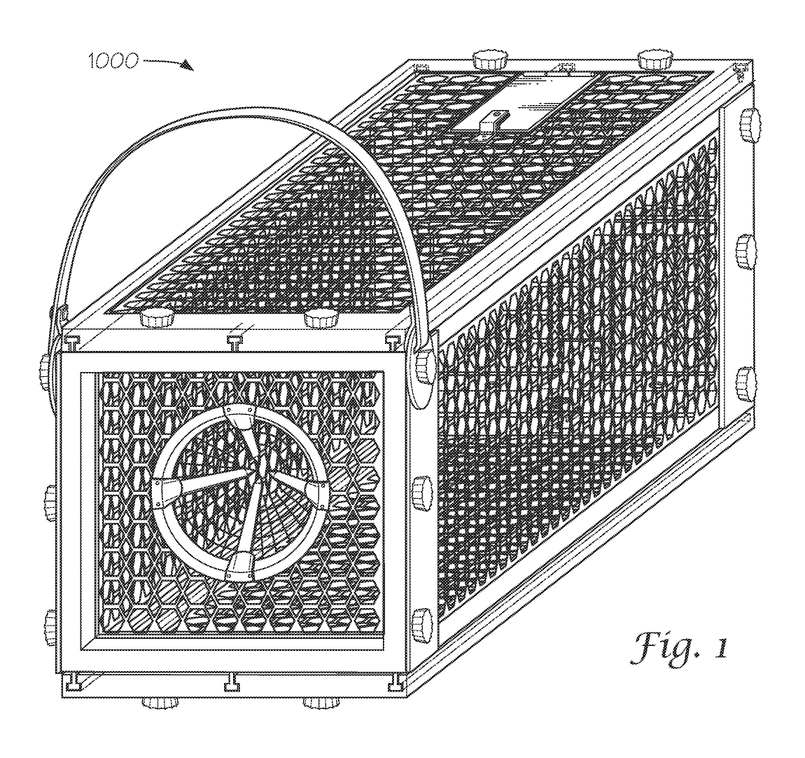

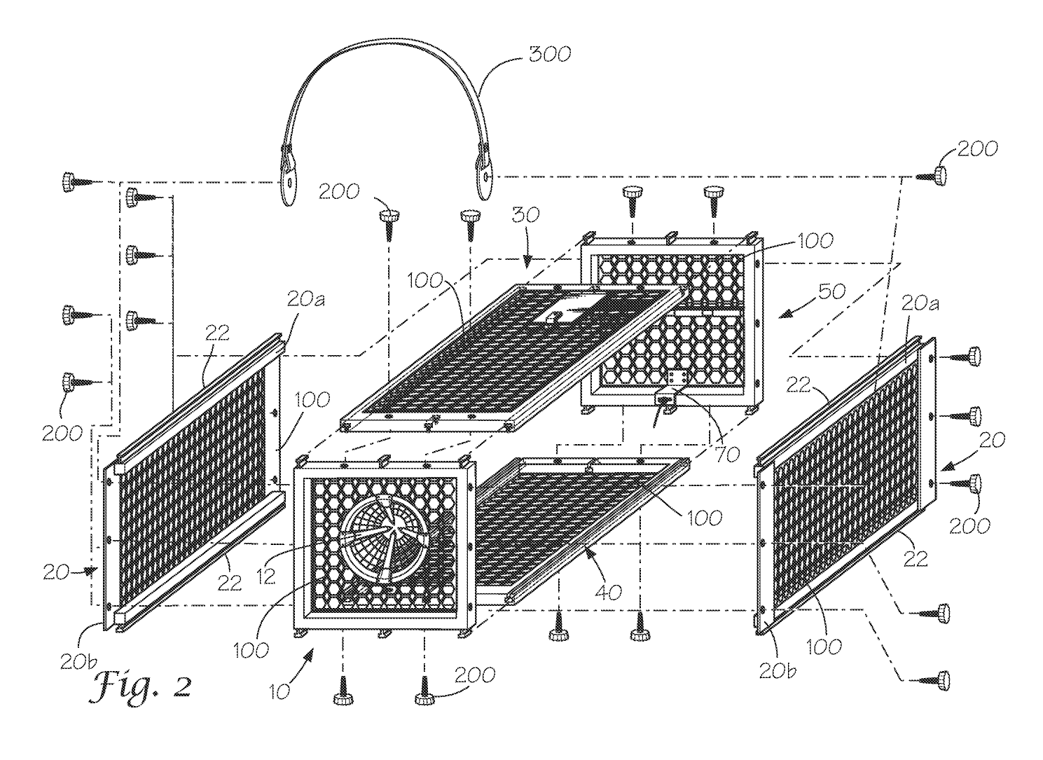

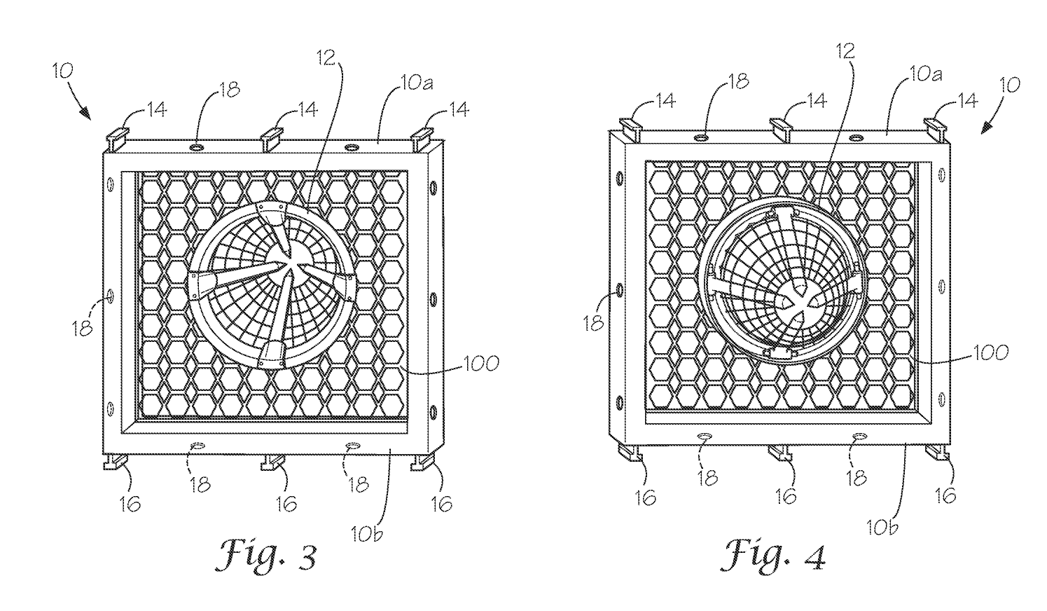

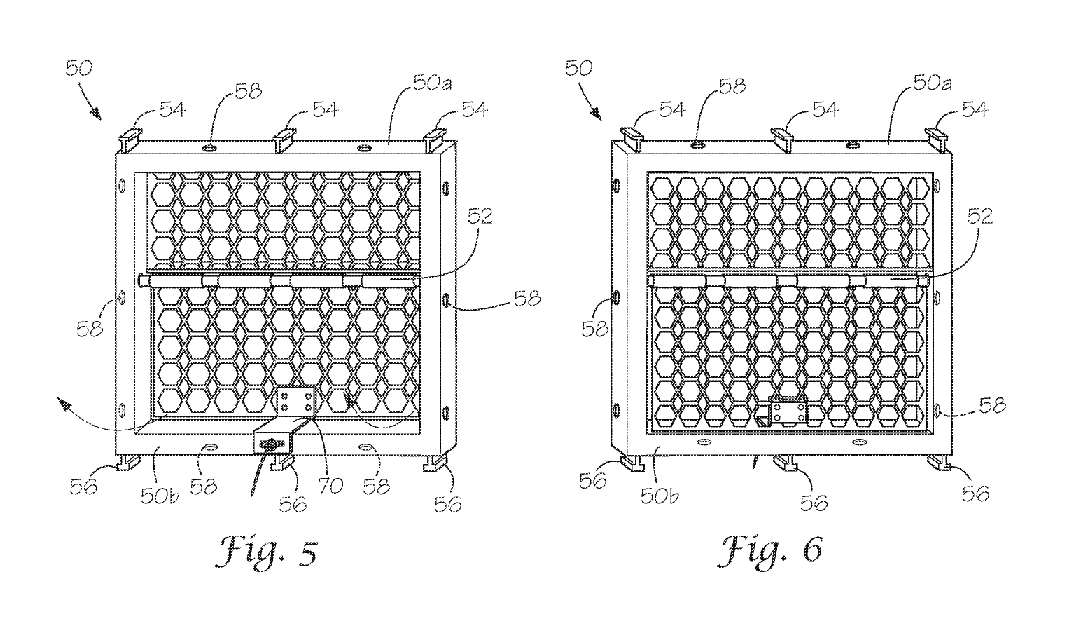

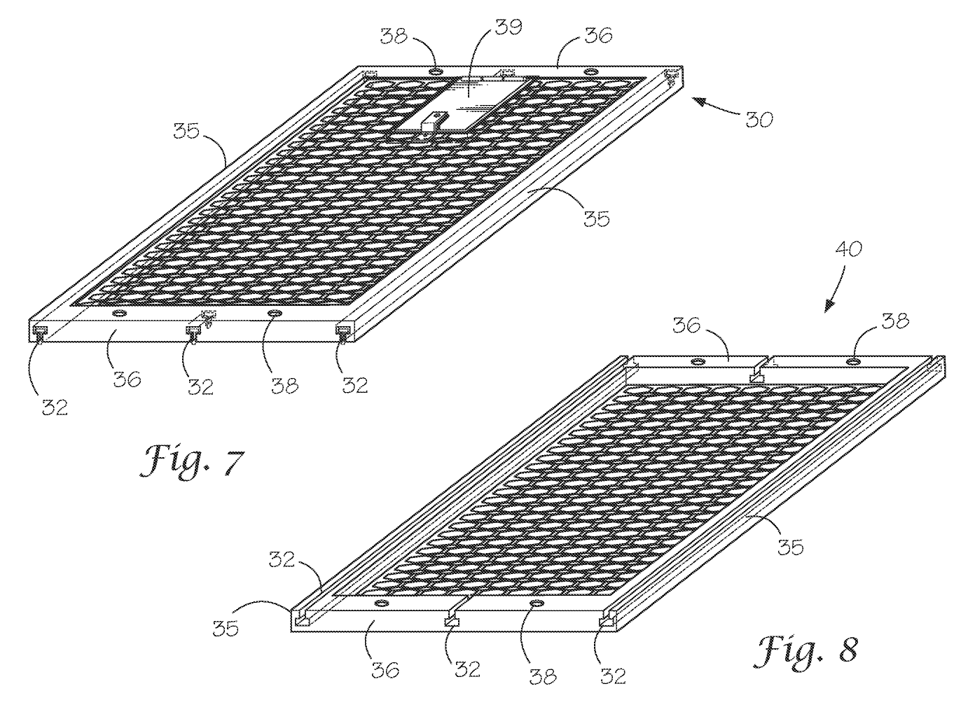

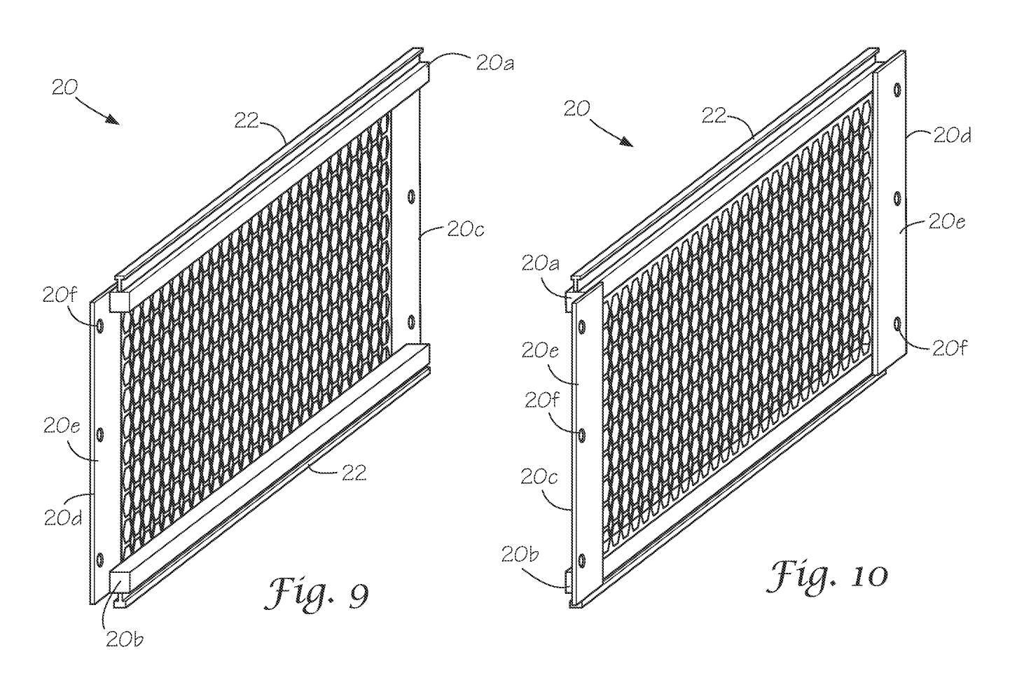

As seen in FIGS. 1-10, the collapsible fish trap 1000 of the present invention comprises of a square front panel 10, the square front panel defines a top 10a and a bottom 10b border. The square front panel 10 defines a funnel 12, three top t-front panel guides 14 and three bottom t-panel guides 16. Each t-front panel guide 14 runs perpendicular to the top 10a and bottom 10b border of the square front panel 10. All borders of the front panel 10 define a plurality of front panel apertures. The square front panel 10 is constructed so that the edges of each square front panel 10 define at least a 3 inch border and the square front panel is made of a hard plastic material. The fish trap 1000 further comprises of two identical side panels 20, the side panels 20 define a top 20a, a bottom 20b, a left 20c, and a right 20d side. Each side panel 20 is also made of a hard plastic. Each side panel's top 20a and bottom 20b side define t-side panel guides 22 that run along the length of each side panel 20. Each side panel's left 20c and right side 20d define solid edges that define at least one side aperture 20f. The fish trap 1000 further comprises of a top 30 and bottom 40 rectangular panel, each rectangular panel 30, 40 defines a longer 35 and a shorter 36 side. Each top 30 and bottom 40 panel is made of hard plastic. The top 30 and bottom 40 rectangular panels define edges 35, 36 and each edge has a 3 inch border. Each sides edge that runs along the length of the longer sides 35, 36 of each rectangular panel 30, 40 define a t-receiving channel 32 and the side edges that run along the length of the shorter sides 36 of each rectangular panel 30, 40 define a central t-receiving channel 34 that runs perpendicular to the length of the shorter sides 36, the shorter sides 36 of each rectangular panel further define two rectangular panel apertures 38, each rectangular panel aperture 38 is adjacent to the central t-receiving channel 34. The fish trap 1000 further comprises of a square rear panel 50, the square rear panel has a top 50a and a bottom 50b border. The square rear panel 50 defines a swing door 52, three top t-rear panel guides 54 and three rear t-panel guides 56. Each t-rear panel guide 54, 56 runs perpendicular to the top and bottom borders of the square rear panels 50. All borders of the square rear panel define a plurality of rear panel apertures 58. The square rear panel 50 is constructed so that the edges of each rear panel define at least a 3 inch border and the square rear panel 50 is made of a hard plastic material. All panels 10, 20, 30, 40, 50 are made of a hard plastic lattice 100 that allows a liquid to flow through. The fish trap 1000 further comprises of screws 200 that are screwed within in apertures 28, 20f, 38, and 58 of the panels 10, 20, 30, 40, and 50 after the fish trap 100 is assembled.

The fish trap 100 is assembled by first placing the bottom side panel 40 on a surface (not shown in drawings) so that the t-receiving channels 32 face upward, then inserting the side panel's 20 t-side panel guides 20b within the t-receiving channels 32 of the bottom side panel 40, next, sliding the top side panel's 30 t-receiving channels 32 on the side panel's 20 t-side panel guides 22, then inserting the front panel's t-front panel guides 14 and 16 within the t-receiving channels 32 of the top side 30 and bottom side 40 panels, next inserting the rear panel's t-rear panel guides 54 and 56 within the t-receiving channels 32 of the top side 30 and bottom side 40 panels, and lastly securing all of the panels 10, 20, 30, 40, and 50 together by screwing the screws 200 within the panels apertures 28, 20f, 38, and 58.

In another embodiment of the present invention, the fish trap 1000, further comprises of a lift belt 300 that attaches to the fish trap 1000.

In still a further embodiment of the present invention, the fish trap's 1000 top rectangular panel further comprises of a bait door 39, the bait door 39 attaches to the hard plastic lattice of the top rectangular panel 30.

In yet another embodiment of the present invention, the fish trap 1000 further comprises of a biodegradable latch system 70. The biodegradable latch system will allow fish to escape fish traps that have been lost after a certain time period. The biodegradable latch system could simply be a tie that rots within a certain time of being in a salt water environment.

The screws 200 of the present invention may be biodegradable screws. The reason for the biodegradable screws is to allow lost fish traps to eventually fall apart; thereby preventing ecological nightmares.

An advantage of the present invention is that it provides a collapsible fish trap that is easily assembled and disassembled; the design of the fish trap allows small boats to maximize the amount of traps that can be transported.

Another advantage of the present invention is that it provides fish traps that are ecologically friendly.

A further advantage of the present invention is that it provides an economical, easy to manufacture, and serviceable fish trap.

The invention being thus described, it will be obvious that the same may be varied in many ways. Such variations are not to be regarded as a departure from the spirit and scope of the invention, and all such modifications are intended to be included within the scope of the following claims.

What is claimed is:

1. A collapsible fish trap, the fish trap comprises:
a square front panel, the square front panel defines a top and a bottom border, the square front panel defines a funnel, three top t-front panel guides and three bottom t-panel guides, each t-front panel guide runs perpendicular to the top and bottom border of the square front panel, all borders of the front panel define a plurality of front panel apertures;
two identical side panels, each side panel defines a top, a bottom, a left, and a right side, the top and bottom side define t-side panel guides that run along the length of each side panel, each side panel's left and right side define solid edges that define at least one side aperture;
a top and a bottom rectangular panel, each rectangular panel defines a longer and a shorter side, the top and bottom rectangular panels define edges, each sides edge that runs along the length of the longer sides of each rectangular panel define a t-receiving channel and the side edges that run along the length of the shorter sides of each rectangular panel define a central t-receiving channel that runs perpendicular to the length of the shorter sides, the shorter sides of each rectangular panel further defines two rectangular panel apertures, each rectangular panel aperture is adjacent to the central t-receiving channel;
a square rear panel, the square rear panel has a top and a bottom border, the square rear panel defines a swing door, three top t-rear panel guides and three rear t-panel guides, each t-rear panel guide runs perpendicular to the top and bottom borders of the square rear panels, all borders of the square rear panel define a plurality of rear panel apertures; and
a plurality of screws, the screws are placed within the apertures after the fish trap is assembled, the fish trap is assembled as follows: the bottom rectangular panel is placed on a surface, then the side panels are mounted on the bottom rectangular panel, then the top rectangular panel is mounted on the side panels, then the front and rear panels are mounted top and the bottom rectangular panels, and lastly the screws are inserted within the apertures of all of the panels,
each panel is made of a hard plastic lattice that allows liquid to flow through.

2. The collapsible fish trap of claim 1, further comprises of a lift belt, the lift belt attaches to the fish trap.

3. The collapsible fish trap of claim 2, wherein top rectangular panel further comprises of a bait door, the bait door attaches to the hard plastic lattice of the top rectangular panel.

4. The collapsible fish trap of claim 3, further comprises of a biodegradable latch system, the biodegradable latch system attaches to the swing door.

5. The collapsible fish trap of claim 4, wherein the screws are biodegradable.
